(19) United States
(12) Patent Application Publication
(10) Pub. No.: US 2013/0173964 A1
(43) Pub. Date: Jul. 4, 2013

(54) METHOD OF MANAGING FAILURE, SYSTEM FOR MANAGING FAILURE, FAILURE MANAGEMENT DEVICE, AND COMPUTER-READABLE RECORDING MEDIUM HAVING STORED THEREIN FAILURE REPRODUCING PROGRAM

(71) Applicant: FUJITSU LIMITED, Kawasaki-shi (JP)

(72) Inventor: Kenji OKANO, San Jose, CA (US)

(73) Assignee: FUJITSU LIMITED, Kawasaki-shi (JP)

(21) Appl. No.: 13/776,802

(22) Filed: Feb. 26, 2013

Related U.S. Application Data
(63) Continuation of application No. PCT/JP2010/064605, filed on Aug. 27, 2010.

(51) Int. Cl. G06F 11/07

(52) U.S. Cl. CPC G06F 11/079
USPC 714/33; 714/48

(57) ABSTRACT

A failure management device includes a stored position obtainer that obtains stored position data that represents a position at which failure data is generated by an information processing apparatus when a failure is occurring; a failure data obtainer that obtains the failure data generated by the information processing apparatus from a memory device, communicably connected to the information processing apparatus and the failure management device, on the basis of the stored position data; and a configuration controller that changes, on the basis of the failure data obtained by the failure data obtainer, a configuration of the failure management device so as to conform to that of the information processing apparatus. This configuration makes it possible to easily reproduce the failure occurred in the information processing apparatus and consequently, a reproducing test can be accomplished efficiently.

### CROSS-REFERENCE TO RELATED APPLICATIONS

This application is a continuation Application of a PCT international application No. PCT/JP2010/064605 filed on Aug. 27, 2010 in Japan, the entire contents of which are incorporated by reference.

### FIELD

The embodiment discussed herein is directed to a method of managing a failure, a system for managing a failure, a failure management device, and a computer-readable recording medium having stored therein a failure reproducing program.

### BACKGROUND

For example, if a failure occurs in an information processing apparatus, such as a server system that a customer uses at a site, the manufacturer of the information processing apparatus sometimes takes a failed part, which caused the failure, back to the factory and carries out the reproducing test of the failure on the failed part.

According to a conventional method of managing such a failure, the failed part is sent to the factory along with a document of failure report from the user. Then, an environment for reproducing test based on the failure report is constructed at the factory and the failure is reproduced under the constructed environment in order to seek the cause of the failure and examine the solution to the failure.

An example of a failure report is generated on the basis of the information that a person in charge of fixing collects from the customer at the site or that an operator at the service center hears from the customer, and takes the form of data or a slip attached to the failed part.
[Patent Literature 1] Japanese Laid-open Patent Publication No. HEI 10-133739.

However, this conventional method of managing a failure frequently has a problem that such a failure report from the site does not have enough information to construct the environment for the reproducing test at the factory.

This makes it difficult to construct the environment for the reproducing test at the factory leading less efficiency in the reproducing test. This further brings inefficiency in specifying the cause of the failure.

### SUMMARY

According to a first aspect of the embodiment, a method for managing a failure occurring in an information processing apparatus by reproducing the failure on a reproducing device, the method includes: at the information processing apparatus, generating, in the occurrence of the failure, failure data related to the failure; storing the generated failure data into a memory device communicably connected to the information processing apparatus and to the reproducing device; storing stored position data that represents a position at which the failure data is stored in the memory device into a memory included in a failed part in which the failure is occurring; at the reproducing device, obtaining the stored position data from the memory device of the failed part; obtaining the failure data from the memory device on the basis of the stored position data; and changing, on the basis of the failure data obtained from the memory device, a configuration of the reproducing device so as to conform to that of the information processing apparatus.

According to a second aspect of the embodiment, a system for managing a failure occurring in an information processing apparatus by reproducing the failure on a reproducing device, the system includes: a memory device, communicably connected to the information processing apparatus and to the reproducing device, wherein the information processing apparatus includes a failure data generator that generates, in the occurrence of the failure, failure data related to the failure, a storing processor that stores the generated failure data into the memory device, and a position data storing processor that stores stored position data that represents a position at which the failure information is stored in the memory device into a memory included in a failed part in which the failure is occurring, and the reproducing device includes a stored position data obtainer that obtains the stored position data from the memory of the failed part; a failure data obtainer that obtains the failure data from the memory device on the basis of the stored position data; and a configuration controller that changes, on the basis of the failure data obtained by the failure data obtainer, a configuration of the reproducing device so as to conform to that of the information processing apparatus.

According to a third aspect of the embodiment, a failure management device that reproduces thereon a failure occurring in a failed part included in an information processing apparatus, the failure management device includes: a stored position obtainer that obtains stored position data that represents a position at which failure data being related to the failure and being generated by the information processing apparatus when the failure is occurring from a memory of the failed part; a failure data obtainer that obtains the failure data from the memory device, communicably connected to the failure management device, on the basis of the stored position data; and a configuration controller that changes, on the basis of the failure data obtained by the failure data obtainer, a configuration of the failure management device so as to conform to that of the information processing apparatus.

According to a fourth aspect of the embodiment, a computer-readable recording medium having stored therein a failure reproducing program for causing a computer to execute a process of reproducing a failure occurring in a failed part in an information processing apparatus, the process includes: obtaining stored position data that represents a position at which failure data being related to the failure and being generated by the information processing apparatus when the failure is occurring from a memory of the failed part; obtaining the failure data from a memory device, being communicably connected to the information processing apparatus and the computer, on the basis of the stored position data; and changing, on the basis of the failure data obtained from the failure data obtainer, a configuration of the computer so as to conform to that of the information processing apparatus.

The object and advantages of the invention will be realized and attained by means of the elements and combinations particularly pointed out in the claims. It is to be understood that both the foregoing general description and the following detailed description are exemplary and explanatory and are not restrictive of the invention.

### BRIEF DESCRIPTION OF DRAWINGS

FIG. 1 is a block diagram schematically illustrating a functional configuration of a failure management system according to a first embodiment;

FIG. 2 is a block diagram schematically illustrating an example of the hardware configuration of a customer system of a failure management system of the first embodiment;

FIG. 3 is a diagram illustrating an example of configuration data in a failure management system of the first embodiment;

FIG. 4 is a diagram illustrating an example of configuration data in a failure management system of the first embodiment;

FIG. 5 is a diagram illustrating an example of log data in a failure management system of the first embodiment;

FIG. 6 is a diagram illustrating an example of a failure log in a failure management system of the first embodiment;

FIG. 7 is a diagram illustrating an example processing performed by a storing processor and a stored position data storing processor included in a failure management system of the first embodiment;

FIG. 8 is a diagram illustrating an example of the hardware configuration of a failure reproducing system included in a failure management system according to the first embodiment;

FIG. 9 is a diagram schematically illustrating the functional configuration of a failure reproducing system included in a failure management system according to the first embodiment;

FIG. 10 is a diagram illustrating an example of processing performed by a failure data obtainer in the failure management system of the first embodiment;

FIG. 11 is a diagram illustrating an example of a configuration data table in the failure management system of the first embodiment;

FIG. 12 is a diagram illustrating an example in which part of the hardware elements in a failure reproducing system of a failure management system of the first embodiment is assumed to be in a not-mounted state;

FIG. 13 is a diagram illustrating an example in which a failure reproducing system is set to have the same domain configuration as that of a customer system in the failure management system of the first embodiment;

FIG. 14 is a diagram illustrating a reproducing script image of a failure management system of the first embodiment;

FIG. 15 is a diagram illustrating a reproducing script of a failure management system of the first embodiment;

FIG. 16 is a diagram illustrating a procedure of automatically setting tracing levels for a failure researcher of a failure management system of the first embodiment;

FIG. 17 is a diagram illustrating test programs in the form of a test program list of a failure management system of a first embodiment; and

FIG. 18 is a flow diagram denoting a succession of procedural steps performed in a failure management system of the first embodiment.

### DESCRIPTION OF EMBODIMENT

Hereinafter, description will now be made in relation to a first embodiment with reference to the accompanying drawings.

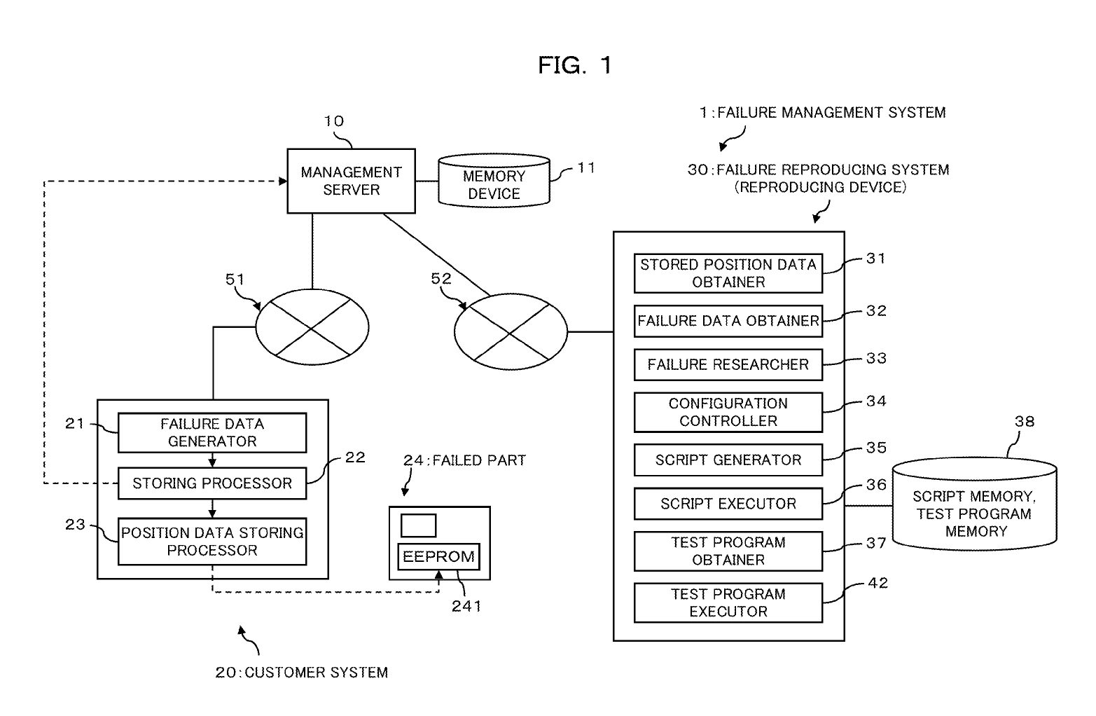

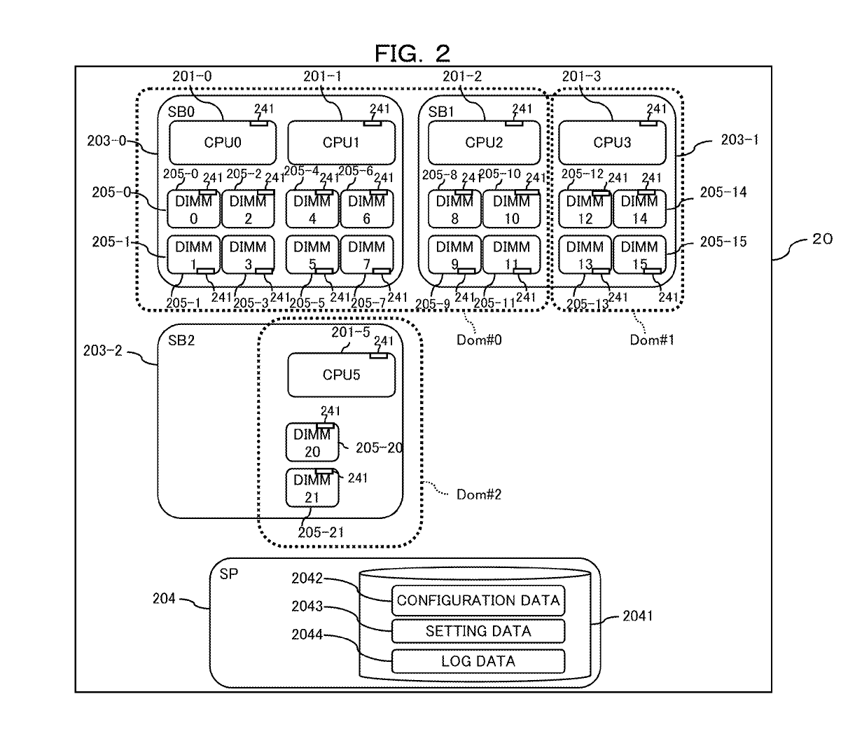

FIG. 1 is a block diagram schematically illustrating the functional configuration of a failure management system 1 according to the first embodiment; and FIG. 2 is a block diagram illustrating the hardware configurations of a customer system 20 included in the failure management system 1.

The failure management system 1 deals with failures occurring in information processing apparatus. Here, the first embodiment assumes that an information processing apparatus (i.e., customer system 20) provided by a manufacturer is used by a customer (user) and that a failure occurring in the information processing apparatus 20 is to be managed.

As illustrated in FIG. 1, the failure management system 1 includes a customer system 20, a management server 10, and a failure reproducing system 30.

The failure management system 1 of the first embodiment includes one or more customer systems 20. However, a single customer system 20 appears in the drawing for convenience and simplification.

The management server 10 is a server computer having a server function and communicably connected to the customer system 20 through a network 51. The management server 10 is disposed at, for example, a support center which deals with inquiries from the customers.

The management server 10 includes a memory device 11 and stores failure data (to be detailed below) that a customer system 20 also to be detailed below transmits thereto through the network 51 into a predetermined region of the memory device 11. An example of the memory device 11 is a Hard Disk Drive (HDD), which has a large capacity and which can therefore store and accumulate large pieces of failure data.

In storing failure data into the memory device 11, the management server 10 notifies the customer system 20 that creates the failure data of stored position data that locates a destination of storing the failure data.

The stored position data is, for example, an IP address for a management server 10 or directory data representing a position where data is stored. In the failure management system 1 of the first embodiment, it is possible to access particular failure data stored in the memory device 11 using the stored position data. The stored position data is, of course, not limited to an IP address and directory data and may be various known methods used for accessing particular data on a network.

The management server 10 is also communicably connected to the failure reproducing system 30 via a network 52. When a failure data obtainer 32 of the failure reproducing system 30 to be detailed below makes an access to failure data by referring to stored position data, the management server 10 passes (sends) the failure data to the failure reproducing system 30.

Any known computer system may serve as the management server 10, and detailed description will be omitted here.

The customer system 20 is an information processer used by a customer. The customer system 20 includes an element having a possibility of causing a failure (disorder) and has a communication function (not illustrated) of sending and receiving data to and from the management server 10 via the network 51.

The first embodiment assumes that the customer system 20 is an information processing apparatus such as a server computer system.

In the example of FIG. 2, the customer system 20 includes hardware elements, such as System Boards (SBs) 203-0 through 203-2, an SP 204, and a non-illustrated chipset. The hardware elements such as SB 203-0 to 203-2 and the chipset collectively form the main unit of the customer system 20.

The SB 203-0 includes Central Processing Units (CPUs) 201-0 and 201-1, and memories 205-0 to 205-7; the SB 203-1 includes CPUs 201-2 and 201-3, and memories 205-8 to 205-15; and the SB 203-2 includes CPU 201-5 and memories 205-20 and 205-21.

The memories 205-0 to 205-15, 205-20, and 205-21 are each a recording region that temporarily stores various pieces of data and programs and are each exemplified by a Dual Inline Memory Module (DIMM). The first embodiment assumes each memory in the customer system 20 is a DIMM and the memories 205-0 to 205-15, 205-20, and 205-21 are also referred to as DIMMs 205-0 to 205-15, 205-20, and 205-21. Hereinafter, when one of the DIMMs is discriminated from the remaining DIMMs, reference numbers 205-0 to 205-15, 205-20, and 205-21 are used, but an arbitrary DIMM is sometimes represented by a reference number 205.

Similarly, one of the SBs is discriminated from the remaining SBs, reference numbers 203-0 to 203-2 are used, but an arbitrary SB is sometimes represented by a reference number 203. One of the CPUs is discriminated from the remaining CPUs, reference numbers 201-0 to 201-7 are used, but an arbitrary CPU is sometimes represented by a reference number 201.

Hereinafter, the SB 203-0 to 203-2 are discriminated from one another by numbers that come after the “- (hyphens)” of the respective reference numbers. The numbers that come after the respective hyphens are sometimes called component numbers. For example, the SB 203-0 is sometimes referred to as the SB 0 and the SB 203-1 is sometimes referred to as the SB 1.

In the main unit of the customer system 20, the CPUs 201 are processors that carry out various controls and calculations, and achieve various functions in the customer system 20 by executing programs stored in a non-illustrated Read Only Memory (ROM).

Hereinafter, the CPUs 201-0 to 201-3 and 201-5 may be sometimes discriminated from one another by component numbers that come after the respective hyphens. For example, the CPU 201-0 is sometimes represented by the CPU0.

Similarly, the DIMMs 205-0 to 205-15, 205-20, and 205-21 may be sometimes discriminated from one another by component numbers that come after the respective hyphens. For example, the CPU 205-0 is sometimes represented by the DIMM 0.

The customer system 20 includes a partitioning function that forms one or more independent domains by virtually dividing and combining the respective hardware elements described above. An operating system and applications can be run on each individual domain formed in the above manner. The partitioning function may be achieved by any known method and the detailed description thereof is omitted here.

In the example of FIG. 2, the partitioning function forms a single domain (Dom#0) including the CPU0, the CPU1 and the DIMM 0 through DIMM 7 on the SB 0, and the CPU2 and the DIMM 8 to the DIMM 11 of the SB 2. In the same manner, the CUP3 and the DIMM 12 to the DIMM 15 on the SB 1 collectively form a single domain (Dom#1); and the CPU5, the DIMM 20, and the DIMM 21 on the SB 2 collectively form a single domain (Dom#2).

The CPUs 201, the DIMMs 205, and other non-illustrated electronic parts in the customer system 20 may have a failure, and are hereinafter called hardware elements.

The CPUs 201, the DIMMs 205, and the electronic parts in the customer system 20 each include a memory 241, which is a data storing device capable of retaining data even when power supply thereto is stopped and which has a capacity of, for example, several KB.

The memory 241 can be achieved by various known methods and is exemplified by an Electrically Erasable Programmable Read Only Memory (EEPROM) or a battery backup memory.

The first embodiment assumes that the memory 241 is an EEPROM, so the memory 241 is represented by the EEPROM 241.

Among the CPUs 201, the DIMMs 205, and the other electronic parts in the customer system 20, a hardware element in which a failure occurred is called a failed part 24. Here, the failed part 24 can be detachable from the customer system 20.

The SP 204 controls and maintains the main unit, and is connected to the CPUs 201 and the DIMMs 205 to control and monitor these connected elements. Besides, the SP 204 displays the respective working states of these elements on a non-illustrated display and collects information related to, for example, a failure.

The SP 204 further includes a storage device 2041, which is a memory device exemplified by a hard disk drive or a Solid State Drive (SSD) and which stores various pieces of data.

As illustrated in FIG. 2, the storage device 2041 includes a configuration data region 2042, a setting data region 2043, and a log data region 2044, each of which is a memory region capable of retaining data and has a capacity of about several dozens MB.

The configuration data region 2042 stores configuration data, which represents the hardware configuration and the software configuration of the customer system 20. Specifically, the configuration data includes hardware configuration data representing the hardware configuration and software configuration data representing the software configuration.

The hardware configuration data includes, for example, data or numbers to identify the respective hardware elements included in the customer system 20. The software configuration data includes, for example, the version of the OS, the version of the firmware, and data (domain configuration data) representing the setting status and the configuration of each domain.

Namely, the configuration data includes hardware configuration data indicating the hardware configuration of the customer system 20, and software configuration data indicating the setting status of the software in the customer system 20.

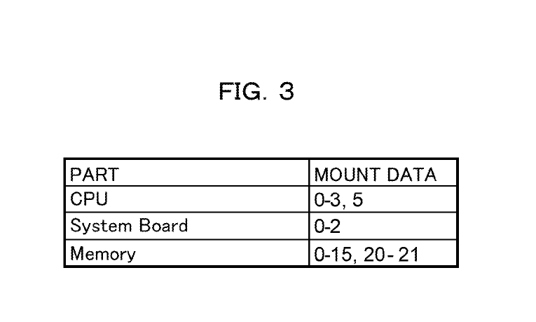

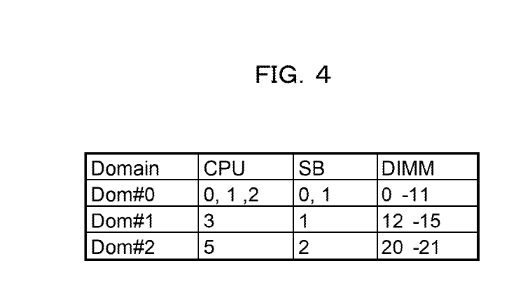

FIGS. 3 and 4 are diagrams illustrating examples of the configuration data in the failure management system 1 of the first embodiment. Specifically, FIG. 3 illustrates an example of the hardware configuration data and FIG. 4 illustrates an example of the software configuration data.

The hardware configuration data of FIG. 3 associates each hardware element (part) with mount data, and specifically indicates the respective component numbers of hardware elements of the CPUs, the SBs, and the DIMMs (memories) mounted on the customer system 20 of FIG. 2.

The software configuration data of FIG. 4 associates each domain with the component numbers of the hardware elements included in the domain. Specifically, the software configuration data includes domain configuration data indicating the configuration of domains of the customer system 20 of FIG. 2, and associates each domain with the respective component numbers of the CPUs 201, the SBs 203, and the DIMMs 205 included in the domain.

The setting data region 2043 stores setting data, which represents various setting values in the customer system 20, such as setting data of the OS and setting data (setting values) of the respective hardware elements, and setting data (setting values) of the SP 204.

The log data region 2044 stores log data, which represents various logs (history data) in the customer system 20, such as logs of various operations and processes performed in the customer system 20 for a predetermined time period and failures occurred in the customer system 20 for a predetermined time period. The operation log includes data on various processes performed in the SP 204 in addition to the operations performed on the customer system 20 by an operator. Namely, the log data includes process history data related to processing performed in the customer system 20 before a failure occurs.

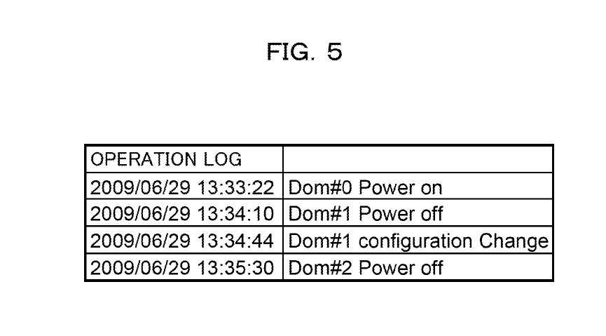

FIG. 5 is a diagram illustrating an example of log data in the failure management system 1 of the first embodiment. In the example of FIG. 5, the log data (operation log) associates processes performed on the domains when the customer system 20 is activated with the date and the time of executing the respective processes.

In the first embodiment, the configuration data region 2042, the setting data region 2043, and the log data region 2044 are included in the storage device 2041. However, the positions of these regions are not limited to this. Alternatively, part of the configuration data region 2042, the setting data region 2043, and the log data region 2044 may be stored in another storage device, and various changes and modifications are suggested without departing from the gist of the first embodiment

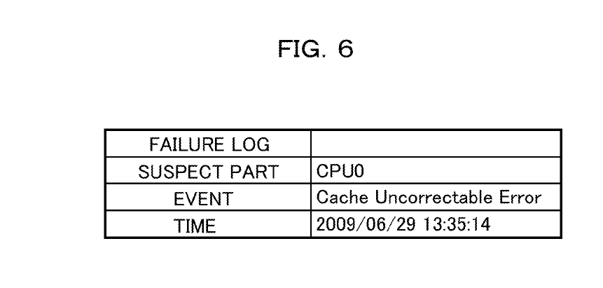

FIG. 6 is a diagram illustrating an example of a failure log in the failure management system 1 of the first embodiment. In the example of FIG. 6, the failure log includes a suspect part, an event occurred, and time of the event. The example of FIG. 6 is a failure log generated when a cache error occurred in the CPU 201.

The item “suspect part” is data to specify a part (failure occurring point) which is judged to have the failure. The example of FIG. 6 indicates that the failure is occurring in the CPU0. The item “event” is data representing the details of the failure occurred. The example of FIG. 6 indicates that an uncorrectable error is occurred in the cache memory of the CPU0. The item “time” represents the date and the time when the failure occurred.

The SP 204 further includes a processor and a ROM, which do not appear in the drawing. Executing a program stored in the ROM, the processor functions as the failure data generator 21, the storing processor 22, and the position data storing processor 23 as illustrated in FIG. 1.

The program to achieve the functions of the failure data generator 21, the storing processor 22, and the position data storing processor 23 is provided in the form of being stored in a computer-readable recording medium such as a flexible disk, a CD (e.g., CD-ROM, CD-R, CD-RW), and a DVD (e.g., DVD-ROM, DVD-RAM, DVD-R, DVD+R, DVD-RW, DVD+RW, HD DVD), a Blu-ray disk, a magnetic disk, an optical disk, and a magneto-optical disk.

The computer reads the program from the recording medium and forwards and stores the program into an internal or external memory for future use. The program may be stored in a storage device (recording medium), such as a magnetic disk, an optical disk, and a magneto-optical disk, and may be provided to a computer from the storage device through a communication route.

The functions of the failure data generator 21, the storing processor 22, and the position data storing processor 23 are achieved by a microprocessor (corresponding to the SP 204 in the first embodiment) executing a program stored in an internal memory (corresponding to a RAM or the ROM in the SP 204 of the first embodiment). Alternatively, a computer may read a program stored in a recording medium and execute the read program.

The failure data generator 21 generates, when a failure occurs in the customer system 20, failure data related to the failure. Specifically, the failure data generator 21 generates the configuration data, the setting data, and the log data as the failure data.

The configuration data, the setting data, and the log data can be generated in the respective known methods. The detailed methods of collecting and generating these data pieces are omitted here.

The storing processor 22 carries out control to store the failure data generated by the failure data generator 21 into the memory device 11 of the management server 10. The storing processor 22 transmits the failure data generated by the failure data generator 21 to the management server 10 via the network 51, and causes the management server 10 to store the failure data into a predetermined region of the memory device 11. The storing processor 22 notifies the position data storing processor 23 of stored position data, which locates the position where the failure data is stored in the memory device 11 of the management server 10.

A predetermined region of the memory device 11 may be allocated to a destination of storing failure data in the memory device 11 in advance and may be set in the storing processor 22, which instructs the management server 10 to store the failure data into the predetermined position allocated to the destination. Alternatively, the management server 10 may store the failure data received from the storing processor 22 in an arbitrary region of the memory device 11 and may notify the storing processor 22 of the region storing the data via the network 51.

The position data storing processor 23 stores the stored position data representing the position of the memory device 11, at which position the failure data is stored, into the EEPROM 241 of the failed part 24. Specifically, the position data storing processor 23 converts the stored position data which is notified from the storing processor 22 or which is allocated in advance into a URL and stores the URL, serving as the stored position data, into the EEPROM 241 of the failed part 24.

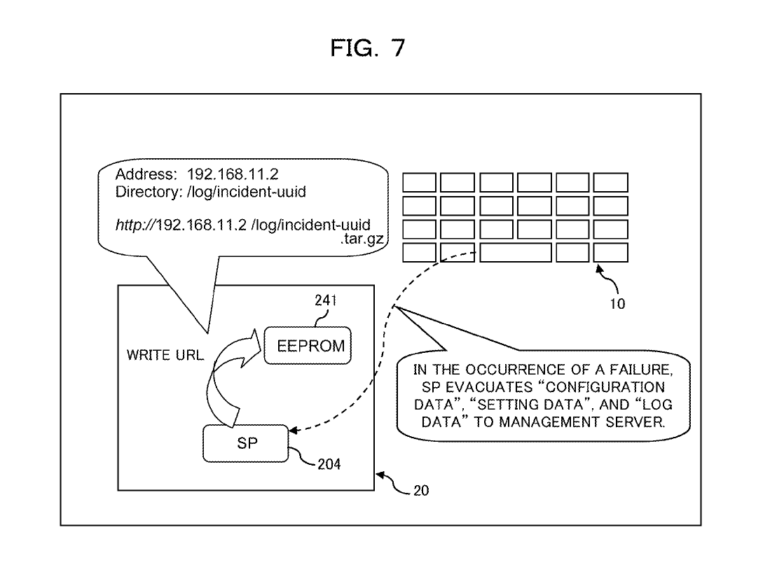

FIG. 7 is a diagram illustrating an example of a process performed by the storing processor 22 and the position data storing processor 23 of the failure management system 1 of the first embodiment. In the example of FIG. 7, the storing processor 22 stores failure data in a position located by the directory of “flog/incident-uuid” of the management server 10 having an address (IP address) of 192.168.11.2.

Here, a part “uuid” of the address represents a unique identifier (ID) to identify a phenomenon (i.e., failure) and is generated by combining, for example, the serial number of the device, the type of failed part, the serial number of the failed part, and time when the failure occurred. This notation makes it possible to uniquely associate, even when multiple failures occur in multiple systems, each event with the failure data related to the event.

The identifier uuid may be generated by combining part of the above data pieces or by using one or more data pieces not mentioned above. Various changes and modification can be suggested without departing from the gist of the first embodiment.

The position data storing processor 23 writes, as the stored position data, the URL of the memory device 11 of the management server 10 which stores the failure data into the EEPROM 241 of the failed part 24. Thereby, the failed part 24 is associated with the failure data stored in the memory device 11.

At this time, the position data storing processor 23 generates a URL including address data to access the failure data stored in the management server 10 and data (uuid) that uniquely identifies the event, and writes the URL into the EEPROM 241.

In the example of FIG. 7, the position data storing processor 23 generates the stored position data in the form of URL “http://192.168.11.2/log/incident-uuid.tar.gz” and stores the URL into the EEPROM 241.

The failed part 24 including the EEPROM 241 storing the stored position data is sent to a factory or the like installing therein a failure reproducing system 30 via a transferring method.

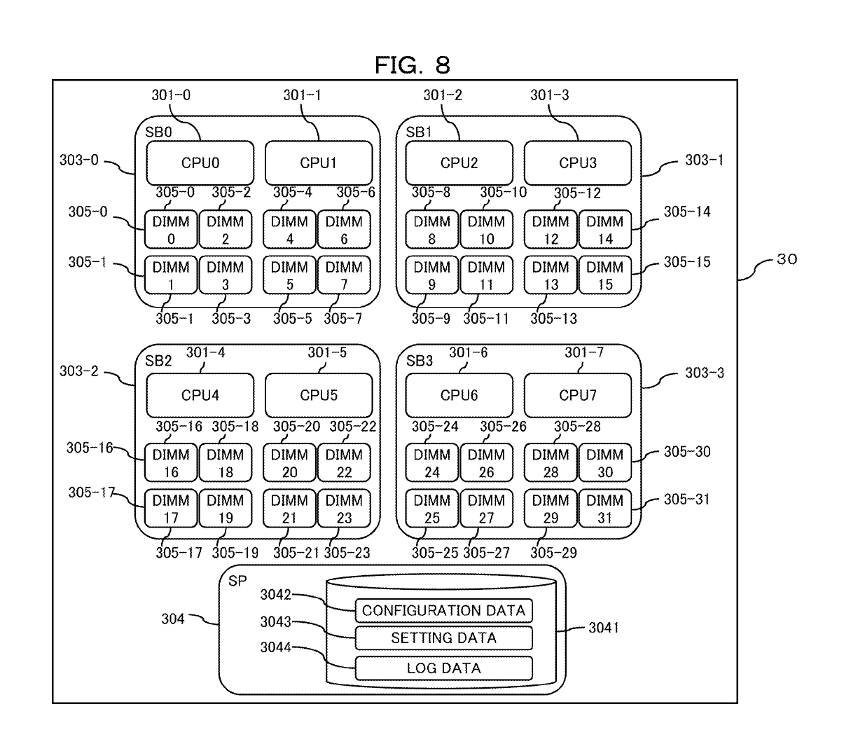

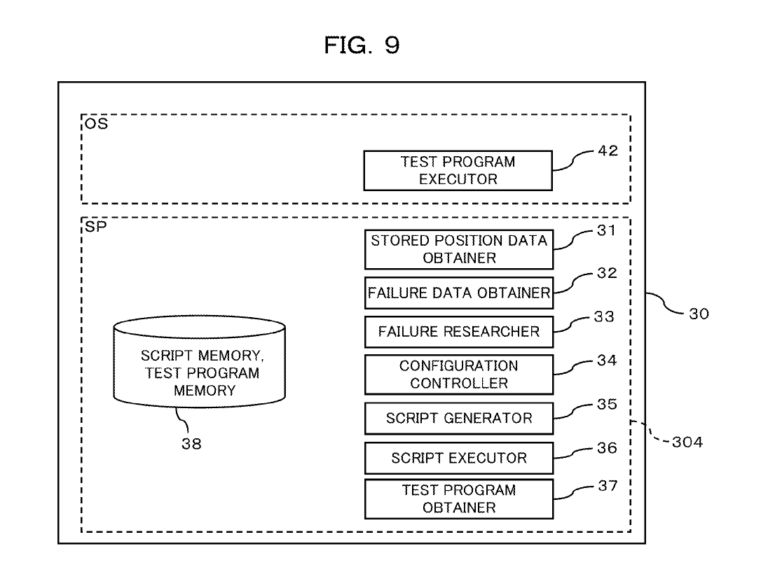

FIG. 8 is a diagram illustrating an example of the hardware configuration of the failure reproducing system 30 included in the failure management system 1 of the first embodiment; and FIG. 9 is a diagram schematically illustrating the functional configuration of the failure reproducing system 30.

The failure reproducing system 30 is an information processing apparatus (reproducing device, failure management device) that carries out a reproducing test of a failure having occurred in a customer system 20. The reproducing test reproduces the failure having occurred in the customer system 20 to examine the failure, specifies the cause of the failure, and finds the way of recovering and avoiding the failure.

The failure reproducing system 30 is an information processing apparatus the same in type as the customer system 20 and includes all the hardware elements that can be physically mounted on the information processing apparatus. Namely, the failure reproducing system 30 is in, for example, a so-called maximum configuration in which physical parts are mounted on all the slots to which hardware elements can be installed. This means that the failure reproducing system 30 includes hardware elements the same as or more than those mounted on the customer system 20.

In the example of FIG. 5, the failure reproducing system 30 includes SBs 303-0 to 303-3, and SP 304. The SBs 303-0 to 303-3 and non-illustrated hardware elements such as a chipset collectively form a main body unit. In addition, the failure reproducing system 30 includes the SP 304.

The SB 0 includes CPUs 301-0 and 301-1, DIMMs 305-0 to 305-7; the SB 1 includes CPUs 301-2 and 301-3, and DIMMs 305-8 through 305-15; the SB 2 includes CPUs 301-4 and 301-5 and DIMMs 305-16 to 305-23; and the SB 3 includes CPUs 301-6 and 301-7 and DIMMs 305-24 to 305-31.

Namely, the failure reproducing system 30 of the example of FIG. 5 consists of four SBs 303, eight CPUs 301, and 32 DIMMs 305.

Hereinafter, the SBs 303-0 to 303-7 may be sometimes discriminated from one another by component numbers that come after the respective hyphens. For example, the SB 303-0 is sometimes represented by the SB 0 and the SB 303-1 is sometimes represented by the SB 1 in the same way.

Similarly, the CPUs 301-0 to 301-7 and the DIMM 305-0 to 305-31 may be sometimes discriminated from one another by component numbers that come after the respective hyphens. For example, the CPU 301-0 is sometimes represented by the CPU0 and the DIMM 305-0 is sometimes represented by the DIMM 0.

The SBs are represented by the reference numbers 303-0 to 303-3 when one SB needs to be discriminated from the remaining SBs, but an arbitrary SB is represented by a reference number 303.

The CPUs represented by the reference numbers 301-0 to 301-7 when one CPU needs to be discriminated from the remaining CPUs, but an arbitrary CPU is represented by a reference number 301. Similarly, the DIMMs are represented by the reference numbers 305-0 to 305-31 when one DIMM needs to be discriminated from the remaining DIMMs, but an arbitrary DIMM is represented by a reference number 305.

The CPUs 301 included in the failure reproducing system 30 are the same or substantially the same as the CPUs 201 included in the customer system 20. Similarly, the DIMMs 305 included in the failure reproducing system 30 are the same or the substantially the same as the DIMMs 205 included in the customer system 20.

The failure reproducing system 30 also includes a partitioning function that forms one or more independent domains by virtually dividing and combining the respective hardware elements described above. An OS and applications can be run on each individual domain formed in the above manner.

In the main unit of the failure reproducing system 30, the CPUs 301-0 to 301-7 are processors each carry out various controls and calculations and each achieve various functions of the failure reproducing system 30 through executing one or more programs stored in a ROM (not illustrated).

A memory 38 is a device such as an HDD and an SSD that stores various pieces of data. The memory 38 functions as a script memory that stores a script and also a test program memory that stores a test program. The script memory and the test program memory will be detailed below.

Each DIMM 305 is a main memory that temporarily stores various pieces of data and programs. When a CPU 301 is executing a program, the program and relevant data pieces are temporarily stored and expanded in the DIMM 305.

Each CPU 301 functions as a test program executor 42 that is to be detailed below through executing one or more programs stored in the ROM or the memory 38.

The SP 304 controls and maintains the main unit, and is connected to the CPUs 301 and the DIMMs 305 to control and monitor these elements. Besides, the SP 304 displays the respective working states of these elements on a non-illustrated display and collects information related to, for example, a failure.

The SP 304 includes a non-illustrated processor. Executing a failure management program stored in the non-illustrated ROM, the memory 38, and other device, the processor functions as a stored position data obtainer 31, a failure data obtainer 32, a failure researcher 33, a configuration controller 34, a script generator 35, a script executor 36, a test program obtainer 37, and a hardware element specifier 41 that are illustrated in FIGS. 1 and 9.

The program to achieve the functions of the stored position data obtainer 31, the failure data obtainer 32, the failure researcher 33, the configuration controller 34, the script generator 35, the script executor 36, the test program obtainer 37, and the hardware element specifier 41 is provided in the form of being stored in a computer-readable recording medium such as a flexible disk, a CD (e.g., CD-ROM, CD-R, CD-RW), and a DVD (e.g., DVD-ROM, DVD-RAM, DVD-R, DVD+R, DVD-RW, DVD+RW, HD DVD), a magnetic disk, an optical disk, and a magneto-optical disk. The computer reads the program from the recording medium and forwards and stores the program into an internal or external memory for future use. The program may be stored in a storage device (recording medium), such as a magnetic disk, an optical disk, and a magneto-optical disk, and may be provided to a computer from the storage device through a communication route.

The functions of the stored position data obtainer 31, the failure data obtainer 32, the failure researcher 33, the configuration controller 34, the script generator 35, the script executor 36, the test program obtainer 37, and the hardware element specifier 41 are achieved by a microprocessor (corresponding to the CPU of the SP 304 in the first embodiment) executing a program stored in an internal memory (corresponding to a RAM or the ROM in the SP 304 of the first embodiment). Alternatively, a computer may read a program stored in a recording medium and execute the read program.

In the failure reproducing system 30, the failed part 24, which has been removed and sent from the customer system 20, is replaced for a corresponding part mounted on the failure reproducing system 30.

Assuming that the failed part 24 is the CPU0 (i.e. CPU 201-0) in the customer system 20, the CPU0 (i.e., CPU 301-0) of the failure reproducing system 30 is removed and then replaced with the failed part 24, that is, CPU 201-0.

After the replacement, the failure reproducing system 30 can refer to stored position data stored in the EEPROM 241 of the failed part 24.

The stored position data obtainer 31 obtains the stored position data, which is generated by the customer system 20 when the failure is occurring, from the EEPROM 241 of the failed part 24. The stored position data obtainer 31 obtains the stored position data from the failed part 24 which is removed and sent from the customer system 20 and which is installed the failure reproducing system 30 in place of the equivalent hardware element. For example, storing the stored position data with a predetermined file name into the EEPROM 241 or storing the data into a predetermined address in the EEPROM 241 makes the stored position data obtainer 31 possible to surely obtain the stored position data with ease.

The failure data obtainer 32 obtains the failure data from the memory device 11 of the management server 10 on the basis of the stored position data obtained by the stored position data obtainer 31.

Upon recognizing that a failed part 24 having stored therein a URL representing the position of storing the failure data is installed, the failure data obtainer 32 obtains the URL from the EEPROM 241 of the failed part 24 and makes an access to the failure data stored in the management server 10 with reference to the obtained URL. The failure data obtainer 32 obtains (downloads) the failure data from the memory device 11, and expands the failure data on a memory (not illustrated) of the SP 304.

If the URL is an address conforming to the hypertext transfer protocol (http), the failure data obtainer 32 accesses the address indicated by the URL via the protocol of http. The failure data obtainer 32 stores the data stored at the position indicated by the address into the storage device 3041 included in the SP 304.

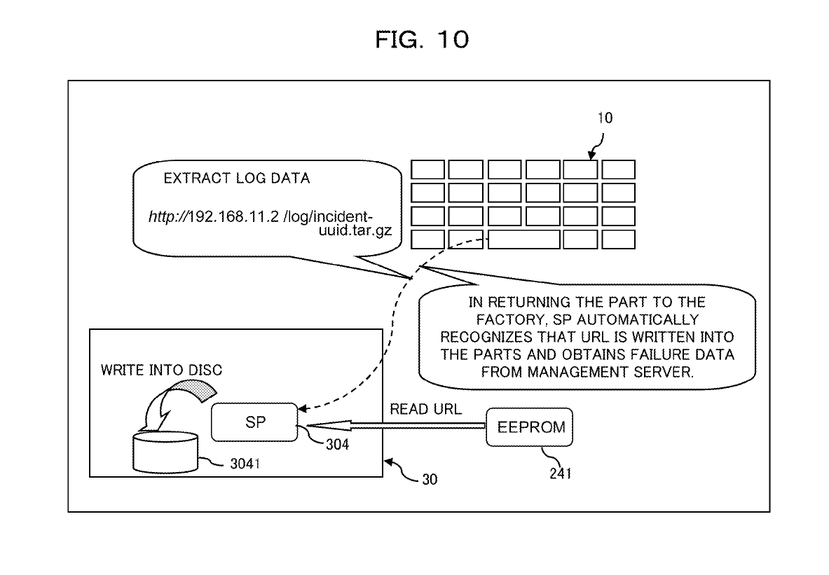

FIG. 10 is a diagram illustrating an example of processing performed by the failure data obtainer 32 of the failure management system 1 of the first embodiment.

In the example of FIG. 10, the failure data obtainer 32 accesses the management server 10 via the network 52 using the URL “http//192.168.11.2/log/incident-uuid.tar.gz” obtained from the EEPROM 241, and obtains the failure data from the management server 10. The obtained failure data is stored into the storage device 3041.

The storage device 3041 includes a configuration data region 3042, a setting data region 3043, and a log data region 3044. The storage device 3041 is exemplified by an HDD or an SSD that stores various pieces of data.

The configuration data region 3042, the setting data region 3043, and the log data region 3044 are memory regions each of which is capable of storing data and has a capacity of several dozens MB.

The configuration data included in the obtained failure data is stored into the configuration data region 3042; the setting data included in the obtained failure data is stored into the setting data region 3043; and the log data included in the obtained failure data is stored into the log data region 3044.

The configuration controller 34 changes, on the basis of the obtained failure data (configuration data, setting data) obtained by the failure data obtainer 32, the hardware configuration and the software configuration of the failure reproducing system 30 so as to conform with those of the customer system 20. Namely, the configuration controller 34 automatically modifies the environment of the failure reproducing system 30 as close to that of the customer system 20 as possible by referring to the obtained failure data.

The configuration controller 34 changes the hardware configuration of the failure reproducing system 30 so as to conform to the hardware configuration of the customer system 20 based on the hardware configuration data of the configuration data included in the failure data.

The configuration controller 34 obtains the hardware configuration of the customer system 20 by referring to the configuration data included in the failure data. Specifically, the configuration controller 34 obtains the configuration data concerning, for example, the CPUs, the SBs, and DIMMs by referring to the configuration data of the customer system 20.

The configuration controller 34 also obtains the hardware configuration of the failure reproducing system 30. The hardware configuration and the software configuration of the failure reproducing system 30 are preferably prepared in advance, but may be occasionally obtained.

The configuration controller 34 compares the hardware configuration of the customer system 20 with that of the failure reproducing system 30, and confirms the differences between these configurations.

If the failure reproducing system 30 carries one or more hardware elements (surplus hardware elements) that are not included in the customer system 20, the configuration controller 34 logically assumes these surplus hardware elements to be in a not-mounted state (unused state).

For example, the hardware configuration of the customer system 20 of FIG. 2 is different from that of the failure reproducing system 30 of FIG. 8 in the point that the customer system 20 does not include the CPU4 and the DIMM 16-DIMM 19, the DIMM 22, and the DIMM 23 included in the SB 2 and the entire SB 3.

In the above case, the configuration controller 34 treats the CPU 4 and the DIMM 16-DIMM 19, the DIMM 22, and the DIMM 23 included in the SB 2 and the entire SB 3 as elements not being mounted on the failure reproducing system 30 (i.e., not-mounted state), so that the hardware configuration of the failure reproducing system 30 conforms to that of the customer system 20.

Namely, the configuration controller 34 makes one or more hardware elements (surplus elements) that are included in the failure reproducing system 30 but that are not included in the customer system 20 into an unused state, so that the hardware configuration of the failure reproducing system 30 conforms to that of the customer system 20.

Here, description will now be made in relation to a manner of making a surplus hardware element in the failure reproducing system 30 into a not-mounted state.

The configuration controller 34 has a function of incorporating and degenerating each hardware element (part) into the system depending on the configuration. Hereinafter, this function is simply referred to as a degeneracy function. A hardware element which is degenerated is logically regarded not to be mounted on the failure reproducing system 30. Using this degeneracy function, the configuration controller 34 assumes that each surplus hardware element is logically made into a not-mounted state.

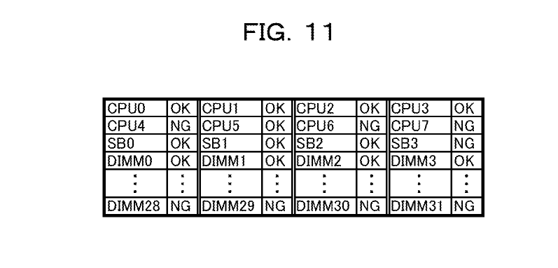

The degeneracy function is achieved using a configuration data table T1 that manages the hardware configuration as illustrated in FIG. 11.

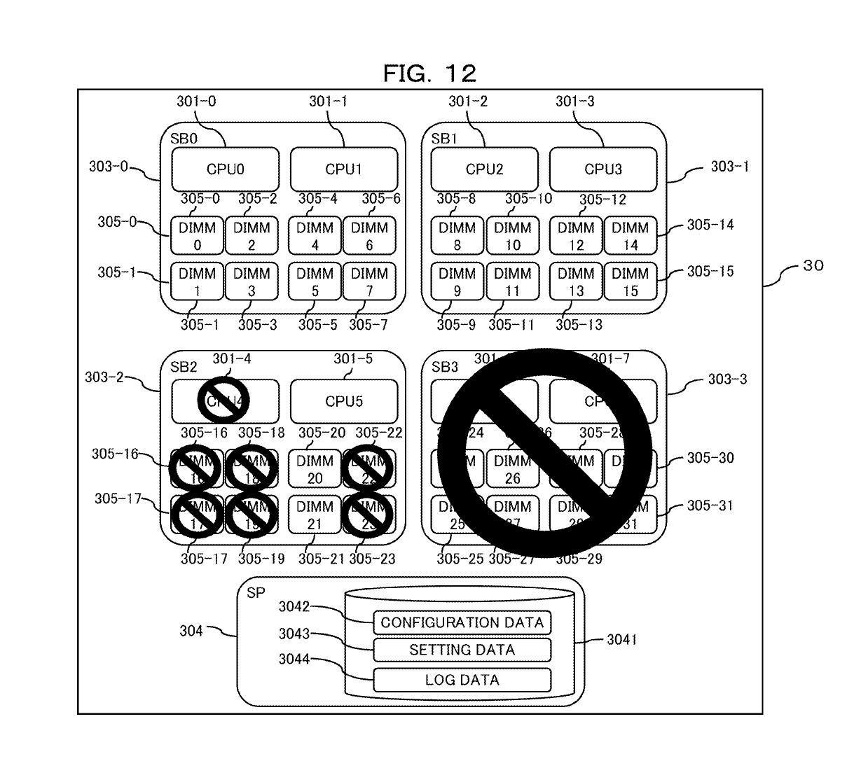

FIG. 11 is a diagram illustrating the configuration data table T1 of the failure management system 1 of the first embodiment; and FIG. 12 is a diagram depicting an example of the failure reproducing system 30 part of the hardware elements of which are made into a not-mounted state in the failure management system 1 of the first embodiment.

The configuration data table T1 associates each hardware element included in the failure reproducing system 30 with information representing a mounted state (OK) or a not-mounted state (NG).

A hardware element associated with “OK” in the configuration data table T1 is treated to be in the mounted state. Conversely, a hardware element associated with “NG” on the configuration data table T1 is treated to be in the not-mounted state and is not recognized by the failure reproducing system 30 so that the element is assumed not to be installed.

The configuration controller 34 modifies the hardware configuration of the failure reproducing system 30 using the degeneracy function. Specifically, the configuration controller 34 logically separates a hardware element which is not included in the customer system 20 from the failure reproducing system 30 by associating the element with a degenerated state (NG) in the configuration data table T1.

If it appears that the customer system 20 includes a hardware element that is not included in the failure reproducing system 30, the configuration controller 34 notifies the fact of the operator (in charge of the reproducing test) by, for example, displaying a corresponding message on a display (not illustrated).

For example, the customer system 20 may include a hardware element, such as a peripheral device added for expanding the function of the customer system 20, that may affect a forthcoming reproducing test. The operator prepares the hardware element and mounts the hardware element onto the failure reproducing system 30 according to the requirement.

The configuration controller 34 sets the software configuration of the failure reproducing system 30 to be the same as that of the customer system 20 by referring to the software configuration data of the configuration data included in the failure data.

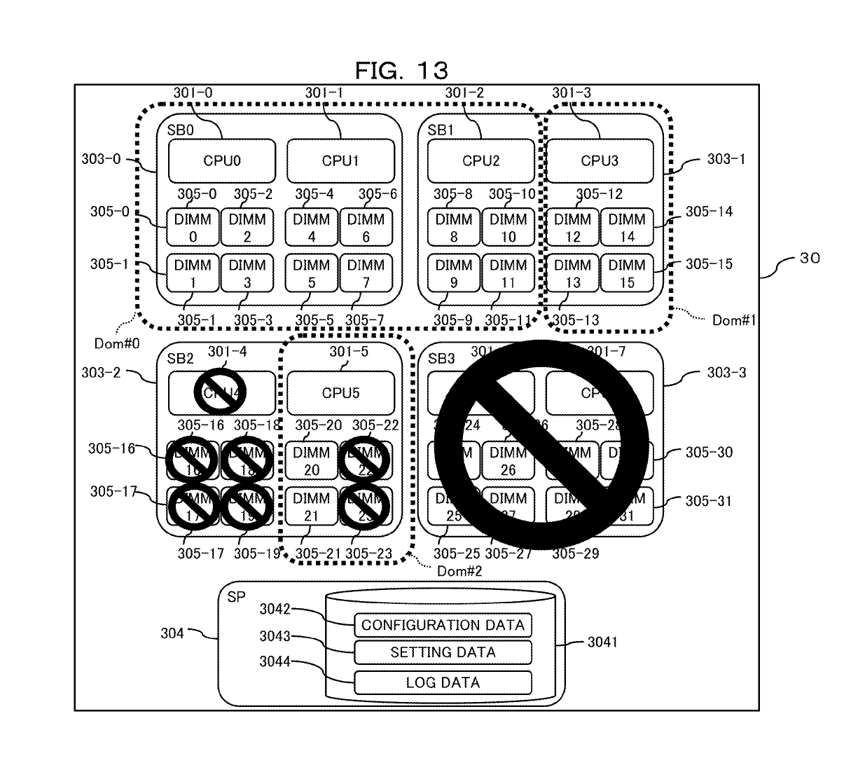

FIG. 13 is a diagram illustrating an example of the failure reproducing system 30 set to have the same domain configuration as customer system 20 in the failure management system 1 of the first embodiment.

For example, the configuration controller 34 refers to the domain configuration data of the configuration data included in the failure data of the customer system 20, and, as illustrated in FIG. 13, sets the domain configuration of the failure reproducing system 30 the same as that of the customer system 20. The domain configuration can be changed in any known method and the detailed description of the methods will be omitted here.

The configuration controller 34 reads the type and the version of a software installed in the customer system 20 from the configuration data included in the failure data of the customer system 20, and installs the software same in the version as that of the customer system 20 into the failure reproducing system 30. Thereby, the configuration controller 34 makes the software configuration of the failure reproducing system 30 with the same as that of the customer system 20.

For example, if the software installed in the customer system 20 is different in version from that installed in the failure reproducing system 30, the configuration controller 34 obtains the image (disk image) of the software of the version installed in the customer system 20 and sets the obtained image into the failure reproducing system 30.

For this purpose, the management server 10, a non-illustrated application server, and memory 38 and other devices (hereinafter called the management server 10 and other devices) preferably store images of all the versions of the software that has a possibility to be installed in the customer system 20.

The configuration controller 34 obtains a software image of a necessary version from the memory 38 or the application server by downloading or copying, and then sets the obtained software image into the failure reproducing system 30.

Alternatively, in setting a software configuration into the failure reproducing system 30, the configuration controller 34 may obtain an installer of the software (including an OS) from the management server 10 and other devices, and may install the software using the installer.

If multiple software pieces are to be installed into the failure reproducing system 30, the installation may sometimes be in conformity with a rule, for example, installing the software pieces in predetermined sequence. In such a case, rule information that clarifies rules of an installation procedure is preferably stored along with information to identify the customer system 20 in the management server 10 or other devices beforehand. In installing one or more software pieces, the configuration controller 34 confirms the presence or the absence of such rule information and, if rule information is present, carries out installation on the rule information.

The configuration controller 34 also installs the firmware of the SP 304 the same as that of the customer system 20. For example, the configuration controller 34 obtains the firmware the same in version as that of the SP 204 of the customer system 20 from the management server 10 and other devices, and applies the obtained firmware to the configuration controller 34 itself to update the firmware.

The script generator 35 generates, on the basis of the log data included in the failure data, a reproducing script that causes the failure reproducing system 30 to reproduce the processing being carried out in the customer system 20 when the failure occurred.

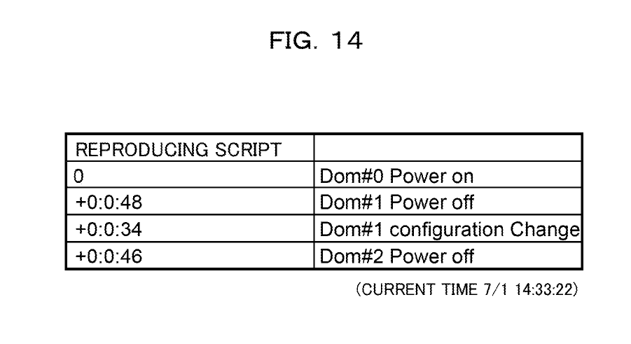

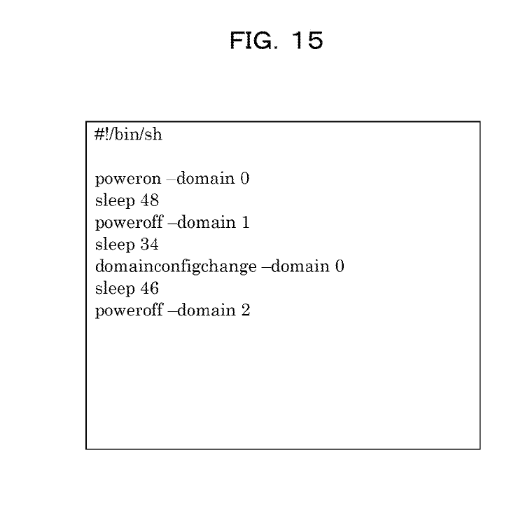

FIG. 14 is diagram illustrating an example of a reproducing script image of the failure management system 1 of the first embodiment; and FIG. 15 illustrates an example of a reproducing script. The reproducing script of FIG. 15 is based on the log data of FIG. 5, and the reproducing script image of FIG. 14 is produced in the course of generating the reproducing script of FIG. 15.

The script generator 35 extracts one or more commands being executed from the processing contents included in the log data (for example, see FIG. 5). As illustrated in FIG. 14, the script generator 35 generates a reproducing script image by calibrating the time of executing each command into elapsed time from the time of executing the first command (in the example of FIG. 5, 2009/06/29 13:33:22).

The script generator 35 generates a reproducing script (shell script) by rewriting each process described in the reproducing script image in conformity with the rule (grammar) of a predetermined program language. In the generation, the script generator 35 puts a command after each process to retard the start of the next process for a time that the process takes. The command to retard the start of the next step is a “sleep” command in the example of FIG. 15.

The sleep commands make the reproducing script to execute the respective steps included in the log data at the same timings at which the steps included in the log data were executed.

As the above, the script generator 35 generates a script (reproducing script) that executes multiple processes included in the log data at the timings that the respective processes were executed in the customer system 20. The generated reproducing script is stored in, for example, memory 38 or other devices.

In the failure reproducing system 30, a script executor 36 that is to be detailed below executes the generated reproducing script (see, for example, FIG. 15), so that multiple processes executed in the customer system 20 when the failure occurred can be carried out at the same timings as those had been executed in the customer system 20. This makes it possible to improve the degree of reproduction in the failure reproducing system 30.

The script executor 36 executes the reproducing script generated by the script generator 35. Namely, the generated reproducing script is executed on the SP 304. Thereby, the failure reproducing system 30 achieves the reproducing test.

The failure researcher 33 refers to the failure log (suspect point specifying data, see FIG. 6, for example) included in the failure data and specifies the hardware element (suspect element) corresponding to the suspect point on the basis of the failure log. For example, the failure log of FIG. 6 indicates that a suspect element is CPU0.

The failure researcher 33 collects trace data in the failure reproducing system 30. The trace data is failure research data and is a kind of log data collected on processing related to a particular hardware element. The failure researcher 33 collects such trace data while the script executor 36 is executing the reproducing script. Collection of trace data can be accomplished in any known method and the detailed description is omitted here.

The failure researcher 33 can arbitrarily set the level (trace level: data collecting level) of trace data to be collected. A high trace level collects a large amount of very detailed data, but the allowable time of the collection is very short. In contrast, a low trace level collects a less amount of data per unit time, but collects data over a longer time period.

The failure management system 1 allows the failure researcher 33 to set the trace level for each processing unit. The default setting (setting at the shipment from the factory) of trace level of the customer system 20 is Middle for all the processing units so that the trace data of various processes is uniformly collected.

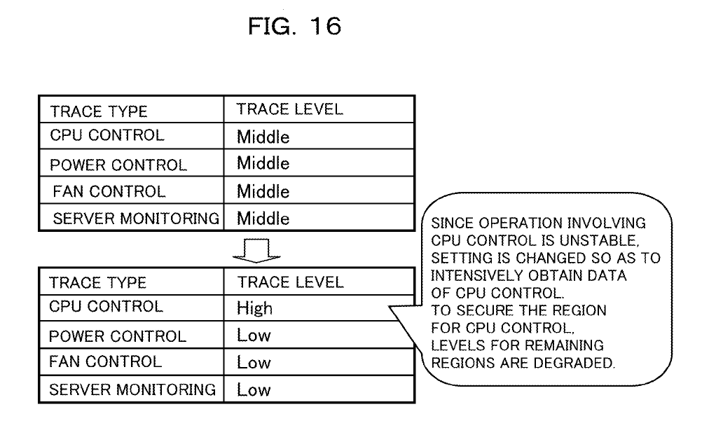

FIG. 16 is a diagram illustrating a manner of automatically setting a trace level by the failure researcher 33 in the failure management system 1 of the first embodiment.

The failure researcher 33 determines a portion of the specified suspect element from which portion trace log is to be intensively collected and raises the trace level of the portion, so that the detailed data of the suspect element, which is estimated to be the cause of the failure, can be collected. In line with the raise of the trace level of the suspect element, the failure researcher 33 lowers the trace levels of processes related to the remaining elements. This prevents the volume of the entire trace data from increasing.

As illustrated in the example of FIG. 6, when determining the CPU0 to be the suspect element by referring to the failure log, the failure researcher 33 raises the trace level of CPU control and lowers the remaining trace levels as illustrated in FIG. 16. Thereby, detailed research data related to the CPU control can be collected.

Besides, the failure researcher 33 collects a log related to execution of the reproducing script by the script executor 36 and then compares the collected log with the failure log included in the failure data. If the comparison concluds that the two logs are almost the same as each other or have a common feature, the failure researcher 33 determines that the failure is reproduced.

The failure researcher 33 notifies the test program obtainer 37 of the hardware element specified to be the suspect part.

The test program obtainer 37 obtains, from the memory 38, a test program corresponding to the hardware element specified to be the suspect element by the failure researcher 33. A test program tests the operation and the function of a hardware element and is executed on a domain. For example, a test program tests an object hardware element by outputting a predetermined test signal to the object hardware element and comparing the response signal from the element with an expected value.

Test programs are prepared for respective kinds of hardware components. For example, test programs for respective hardware elements are stored in the memory 38 in advance.

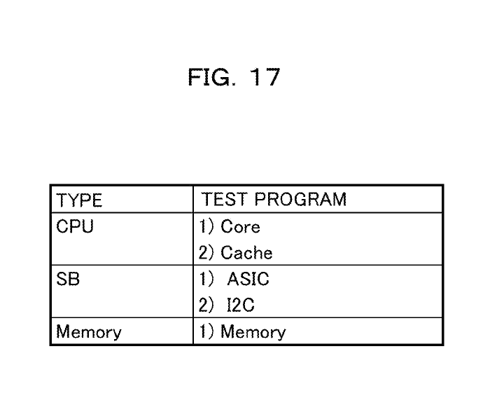

FIG. 17 is a diagram illustrating test programs in the form of a test program list of the failure management system 1 of the first embodiment.

In the example of FIG. 17, the test program list includes five test programs classified according to the kinds of hardware elements (three kinds).

Specifically, the test program list includes two test programs related to the CPUs; one for testing the CPU core (Core) and the other for testing the CPU cache (Cache).

The test program list includes two test programs related to the SBs; one for testing an Application Specific Integrated Circuit (ASIC) and the other for testing an Inter-Integrated Circuit (I2C). The test program list further includes a test program related to the memories (DIMMs).

The test program obtainer 37 selects and obtains the test program suitable for a hardware element specified to be the suspect element among multiple test programs stored in the memory 38 by referring to the test program list of FIG. 17.

Specifically, the test program obtainer 37 refers to the event included in the log data of the failure data and narrows the range to be tested according to the event.

For example, since the failure log of FIG. 6 states that the suspect element is the CPU0 and the event is a “Cache Uncorrectable Error”, it is possible to grasp that the failure is an error related to the cache in the CPU. On the basis of the above failure log, the test program obtainer 37 selects a test program that tests the CPU cache among test programs on the test program list.

The test programs may be stored in the memory device 11 of the management server 10 and other device different from the memory 38.

The SP 304 has a domain-console function that logs in one of the domains and controls the OS executed on the domain. Using the domain-console function, the SP 304 executes the test program selected and obtained by the test program obtainer 37 on the OS.

Specifically, the domain-console function of the SP 304 allows the CPU 301 to function as a test program executor 42 that executes, on the domain, a test program obtained by the test program obtainer 37.

The failure reproducing system 30 repeats execution of a reproducing script by the script executor 36 and execution of a test program by the test program executor 42 until the failure event is correctly reproduced. The reproducing test is stopped when an event the same as failure occurred in the customer system 20 occurs in the failure reproducing system 30.

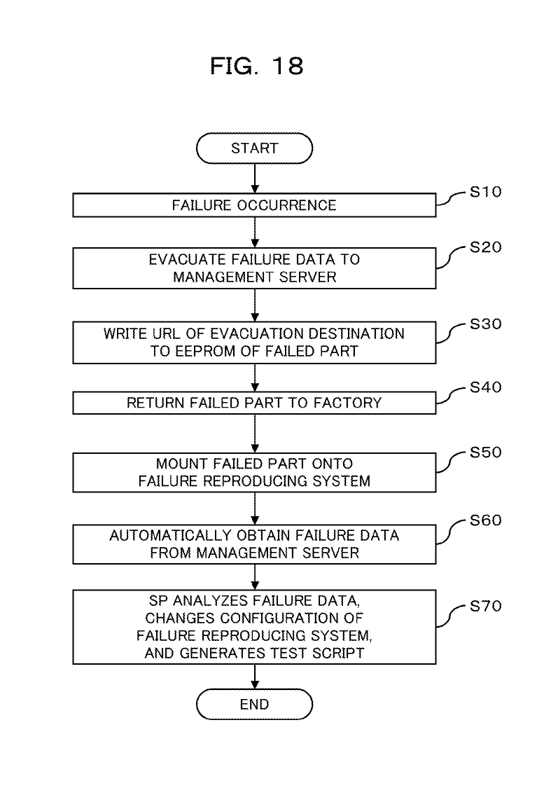

A succession of procedural steps performed in the failure management system 1 of the first embodiment will now be described with reference to a flow diagram (steps S10-S70) of FIG. 18.

Upon occurrence of a failure (disorder) in a customer system 20 (step S10), the SP 204 of the customer system 20 generates failure data (configuration data, setting data, and log data) and the storing processor 22 evacuates the generated failure data to the management server 10 (step S20).

In the customer system 20, the position data storing processor 23 writes the URL (stored position data) of the evacuation destination (storing destination) of the failure data into the EEPROM 241 of a failed part 24 (step S30). Then the failed part 24 is returned to a factory and the failure reproducing system 30 disposed in the factory carries out a failure reproducing test on the failed part 24 (step S40).

At the factory, an operator mounts the failed part 24 onto the failure reproducing system 30 (step S50). Upon installation of the failed part 24 into the failure reproducing system 30, the stored position data obtainer 31 reads the URL from the EEPROM 241 of the failed part 24.

The failure data obtainer 32 accesses to the management server 10 via the network 52 using the read URL, and obtains the failure data (step S60).

After that, the configuration controller 34 of the failure reproducing system 30 changes the hardware configuration and the software configuration of the failure reproducing system 30 so as to conform to those of the customer system 20 on the basis of the obtained failure data.

In the failure reproducing system 30, the script generator 35 generates a reproducing script that causes the failure reproducing system 30 to reproduce the processes executed in the customer system 20 when the failure is occurring on the basis of the log data included in the failure data. The test program obtainer 37 obtains a test program to test a hardware element determined to be the suspect element, which is estimated by the cause of the failure, from the memory 38 on the basis of the failure data (step S70).

The failure reproducing system 30 repeats execution of the reproducing script by the script executor 36 and execution of the test program by the test program executor 42 until the failure occurred in the customer system 20 is correctly reproduced. The result of the test is regularly notified to the operator.

For example, the failure researcher 33 collects the log of the execution of the reproducing script by the script generator 35 and compares the collected log and the failure log included in the failure data. As a result of the comparison, if the two logs are almost the same as each other or have a common feature, the failure researcher 33 determines that the failure is reproduced.

At that time, the failure researcher 33 also sets the trace level based on the failure log included in the failure data, and collects trace data in accordance with the set trace level.

As the above, in the failure management system 1 of the first embodiment, the storing processor 22 stores failure data related to a failure occurred in the customer system 20 into the memory device 11 of the management server 10 via the network 51. This eliminates the requirement of limiting the data size of the failure data, and, for example, makes it possible to pass log data having large capacity to the failure reproducing system 30. Advantageously, the failure reproducing system 30 can obtain sufficient log data to be used for the reproducing test, so that efficiency in reproducing the failure can be improved.

Since the position data storing processor 23 stores stored position data that locates a position at which the failure data is stored in the memory device 11 into the EEPROM 241 of the failed part 24, the capacity of the EEPROM 241 can be small to reduce the costs for hardware elements and the entire customer system 20. Furthermore, the failed part 24 and the failure data can be surely associated with each other, which is very convenient because, for example, it is possible to eliminate the possibility of losing the failure data during returning the failed part 24 back to the factory.

Consequently, the failure data can be surely passed to the failure reproducing system 30 and the efficiency in the reproducing test in the failure reproducing system 30 can be enhanced. The efficiency in a series of processes to specify the cause of the failure can be improved.

Such an efficient reproducing test can shorten the time to specify the cause of the failure, which can improve the quality of the product.

On the basis of the failure data (configuration data, setting data), the configuration controller 34 modifies the environment, such that each of the hardware configuration and the software configuration of the failure reproducing system 30 is as close to that of the customer system 20 in the occurrence of failure as possible. This can efficiently carries out the reproducing test.

Using the degeneracy function, the configuration controller 34 assumes that one or more surplus hardware elements in the failure reproducing system 30 are logically in the not-mounted state. This efficiently changes the hardware configuration of the failure reproducing system 30 with ease. Besides, the configuration controller 34 changes the domain configuration of the failure reproducing system 30 so as to conform to that of the customer system 20, so that the domain configuration of the failure reproducing system 30 can be efficiently changed with ease.

The script generator 35 generates a reproducing script that reproduces the processes executed in the customer system 20 when the failure occurred in the customer system 20 on the basis of the log data included in the failure data, and the script executor 36 executes the reproducing script. Thereby, the failure reproducing system 30 reproduces the multiple processes performed when the failure occurred in the customer system 20 at the same timing as those of the respective processes performed in the customer system 20. Consequently, the degree of reproducing the failure in the failure reproducing system 30 can be improved.

Test programs for respective hardware elements are prepared in advance, and the test program obtainer 37 obtains the test program corresponding to a hardware element determined to be the suspect element related to the failure. Then the test program executor 42 executes the selected test program, so that the test on the suspect element using the test program can be accomplished rapidly.

In the first embodiment, a computer is a concept of a combination of hardware and an Operating System (OS), and means hardware which operates under the control of the OS. Otherwise, if a program operates hardware independently of an OS, the hardware corresponds to the computer. Hardware includes at least a microprocessor such as a CPU and means to read a computer program recorded in a recording medium. In the first embodiment, the customer system 20 and the failure reproducing system 30 serve to function as computers.

The present invention should by no means be limited to the above first embodiment, and various changes and modifications can be suggested without departing from the gist of the present invention.

For example, the first embodiment illustrates the CPUs and the DIMMs serving as the hardware elements in the failure reproducing system 30, but omits illustration of the remaining hardware elements for the convenience. However, the configuration of the failure reproducing system 30 is not limited to the above and the failure reproducing system 30 may, of course, include additional hardware elements other than the CPUs or the DIMMs. This configuration of the failure reproducing system 30 can be modified and changed without departing from the sprit of the first embodiment.

Similarly, the first embodiment assumes that a CPU 201 or a DIMM 205 included in the customer system 20 is the failed part 24, but the failed part 24 is not limited to this. Alternatively, another hardware element such as a cooling fan or power supplying device may be the failed part 24, which can be changed and modified without departing from the sprit of the first embodiment. In this case, such another hardware element such as a cooling fan or power supplying device directly and indirectly includes the memory EEPROM 241.

The above disclosure of the first embodiment makes those ordinarily skilled in the art possible to carry out and produce the method of managing a failure, the system for managing a failure, the failure management device, and the computer-readable recording medium having stored therein a failure reproducing program of the present invention.

The technique disclosed herein brings at least one of the following effects and advantages:

(1) there is no need to limit the data size of the failure data; for example, log data having a large capacity can be passed to the failure reproducing device so that efficiency in reproducing the failure can be improved;

(2) an information processing apparatus can be manufactured at a lower cost; and

(3) the failure data can be surely passed to the failure reproducing device, so that the efficiency in reproducing test and the efficiency in a series of processes to specify the cause of the failure can be both enhanced.

All examples and conditional language recited herein are intended for the pedagogical purposes of aiding the reader in understanding the invention and the concepts contributed by the inventor to further the art, and are not to be construed limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. A method for managing a failure occurring in an information processing apparatus by reproducing the failure on a reproducing device, the method comprising:
at the information processing apparatus,
generating, in the occurrence of the failure, failure data related to the failure;
storing the generated failure data into a memory device communicably connected to the information processing apparatus and to the reproducing device;
storing stored position data that represents a position at which the failure data is stored in the memory device into a memory included in a failed part in which the failure is occurring;
at the reproducing device,
obtaining the stored position data from the memory of the failed part;
obtaining the failure data from the memory device on the basis of the stored position data; and
changing, on the basis of the failure data obtained from the memory device, a configuration of the reproducing device so as to conform to that of the information processing apparatus.

2. The method according to claim 1, wherein:
the failure data includes hardware configuration data representing a hardware configuration of the information processing apparatus; and
in the changing, the configuration of the reproducing device is changed so as to conform to that of the information processing apparatus by making, on the basis of the hardware configuration data, one or more hardware elements which are included in the reproducing device but which are not included in the information processing apparatus into an unused state.

3. The method according to claim 1, wherein:
the failure data includes software setting data representing a state of software setting of the information processing apparatus; and
in the changing, software setting of the reproducing device is set the same as that of the information processing apparatus on the basis of the software setting data.

4. The method according to claim 1, wherein:
the failure data includes processing history data related to processing being carried out in the information processing apparatus before the failure occurs; and
the method further comprises
at the reproducing device,
generating a reproducing script that causes the reproducing device to reproduce the processing being carried out in the information processing apparatus on the basis of the processing history data before the failure occurs, and
executing the generated reproducing script.

5. The method according to claim 1, wherein
the method further comprising storing respective test programs for a plurality of hardware elements of the information processing apparatus into a test program memory;
the failure data includes a suspect point specifying data representing a suspect point likely to cause the failure; and
the method further comprises
at the reproducing device
specifying a hardware element corresponding to the suspect point based on the suspect point specifying data among the plurality of hardware elements of the information processing apparatus,
obtaining a test program for the hardware element specified in the specifying from the test program memory, and
executing the obtained test program.

6. A system for managing a failure occurring in an information processing apparatus by reproducing the failure on a reproducing device, the system comprising:
the information processing apparatus;
the reproducing device; and
a memory device, communicably connected to the information processing apparatus and to the reproducing device, wherein
the information processing apparatus comprises
a failure data generator that generates, in the occurrence of the failure, failure data related to the failure,
a storing processor that stores the generated failure data into the memory device, and
a position data storing processor that stores stored position data that represents a position at which the failure information is stored in the memory device into a memory included in a failed part in which the failure is occurring, and
the reproducing device comprises
a stored position data obtainer that obtains the stored position data from the memory of the failed part;
a failure data obtainer that obtains the failure data from the memory device on the basis of the stored position data; and
a configuration controller that changes, on the basis of the failure data obtained by the failure data obtainer, a configuration of the reproducing device so as to conform to that of the information processing apparatus.

7. The system according to claim 6, wherein
the failure data includes hardware configuration data representing a hardware configuration of the information processing apparatus; and
the configuration controller changes the configuration of the reproducing device so as to conform to that of the information processing apparatus by making, on the basis of the hardware configuration data, one or more hardware elements which are included in the reproducing device but which are not included in the information processing apparatus into an unused state.

8. The system according to claim 6, wherein:
the failure data includes software setting data representing a state of software setting of the information processing apparatus; and
the configuration controller sets software setting of the reproducing device the same as that of the information processing apparatus on the basis of the software setting data.

9. The system according to claim 6, wherein:
the failure data includes processing history data related to processing being carried out in the information processing apparatus before the failure occurs; and
the reproducing device further comprises
a script generator that generates a reproducing script that causes the reproducing device to reproduce the processing being carried out in the information processing apparatus when the failure is occurring, and
a script executor that executes the generated reproducing script.

10. The system according to claim 6, further comprising a test program memory that stores respective test programs for a plurality of hardware elements of the information processing apparatus, wherein
the failure data includes a suspect point specifying data representing a suspect point likely to cause the failure, and
the reproducing device further comprises
a hardware element specifier that specifies a hardware element corresponding to the suspect point based on the suspect point specifying data among the plurality of hardware elements of the information processing apparatus,
a test program obtainer that obtains a test program for the hardware element specified by the hardware element specifier from the test program memory, and
a test program executor the test program obtained by the test program obtainer.

11. A failure management device that reproduces thereon a failure occurring in a failed part included in an information processing apparatus, the failure management device comprising:
a stored position data obtainer that obtains stored position data that represents a position at which failure data being related to the failure and being generated by the information processing apparatus when the failure is occurring from a memory of the failed part;
a failure data obtainer that obtains the failure data from a memory device, communicably connected to the failure management device, on the basis of the stored position data; and
a configuration controller that changes, on the basis of the failure data obtained by the failure data obtainer, a configuration of the failure management device so as to conform to that of the information processing apparatus.

12. The failure management device according to claim 11, wherein
the failure data includes hardware configuration data representing a hardware configuration of the information processing apparatus; and
the configuration controller changes the configuration of the reproducing device so as to conform to that of the information processing apparatus by making, on the basis of the hardware configuration data, one or more hardware elements which are included in the reproducing device but which are not included in the information processing apparatus into an unused state.

13. The failure management device according to claim 11, wherein:
the failure data includes software setting data representing a state of software setting of the information processing apparatus; and
the configuration controller sets software setting of the reproducing device the same as that of the information processing apparatus on the basis of the software setting data.

14. The failure management device according to claim 11, wherein:
the failure data includes processing history data related to processing being carried out in the information processing apparatus before the failure occurs; and
the failure management device further comprises
a script generator that generates a reproducing script that causes the failure management device to reproduce the processing being carried out in the information processing apparatus when the failure is occurring, and
a script executor that executes the generated reproducing script.

15. The failure management device according to claim 11, wherein the failure data includes a suspect point specifying data representing a suspect point likely to cause the failure, and
the failure management device further comprises
a hardware element specifier that specifies a hardware element corresponding to the suspect point based on the suspect point specifying data among the plurality of hardware elements of the information processing apparatus,
a test program obtainer that obtains a test program for the hardware element specified by the hardware element specifier from a test program memory, and
a test program executor that executes the test program obtained by the test program obtainer.

16. A computer-readable recording medium having stored therein a failure reproducing program for causing a computer to execute a process of reproducing a failure occurring in a failed part in an information processing apparatus, the process comprising:
obtaining stored position data that represents a position at which failure data being related to the failure and being generated by the information processing apparatus when the failure is occurring from a memory of the failed part;
obtaining the failure data from a memory device, being communicably connected to the information processing apparatus and the computer, on the basis of the stored position data; and
changing, on the basis of the failure data obtained from the memory device, a configuration of the computer so as to conform to that of the information processing apparatus.

17. The computer-readable recording medium according to claim 16, wherein:
the failure data includes hardware configuration data representing a hardware configuration of the information processing apparatus; and
the program further instructs the computer to change the configuration of the reproducing device so as to conform to that of the information processing apparatus by making, on the basis of the hardware configuration data, one or more hardware elements which are included in the reproducing device but which are not included in the information processing apparatus into an unused state.

18. The computer-readable recording medium according to claim 16, wherein:
the failure data includes software setting data representing a state of software setting of the information processing apparatus; and
the program further instructs the computer to set software setting of the reproducing device the same as that of the information processing apparatus on the basis of the software setting data.

19. The computer-readable recording medium according to claim 16, wherein:
the failure data includes processing history data related to processing being carried out in the information processing apparatus before the failure occurs; and
the program further instructs the computer to execute the process comprising
generating a reproducing script that causes the computer to reproduce the processing being carried out in the information processing apparatus when the failure is occurring, and
executing the generated reproducing script.

20. The computer-readable recording medium according to claim 16, wherein:
the failure data includes a suspect point specifying data representing a suspect point likely to cause the failure; and
the program further instructs the computer to execute the process comprising
specifying a hardware element corresponding to the suspect point based on the suspect point specifying data among the plurality of hardware elements of the information processing apparatus,
obtaining a test program for the hardware element specified by the hardware element specifier from a test program memory, and
executing the obtained test program.
